(19) United States
(12) Patent Application Publication
(10) Pub. No.: US 2006/0202136 A1
(43) Pub. Date: Sep. 14, 2006

(54) Method of and system for obtaining radiation image signal

(75) Inventors: Takao Kuwabara, Kanagawa-ken (JP); Hiroyuki Karasawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/370,054

(22) Filed: Mar. 8, 2006

(30) Foreign Application Priority Data
Mar. 8, 2005 (JP) 063726/2005

(51) Int. Cl. G01N 23/04

(52) U.S. Cl. 250/586

(57) ABSTRACT

A stimulable phosphor sheet is conveyed in a sub-scanning direction while projecting the stimulating light in the main scanning direction, an exposed area on the stimulable phosphor sheet is imaged on each light receiving portion of a line sensor which is formed by causing the same to correspond to a sub-scanning direction, the stimulated light emitted from the exposed area is photoelectrically converted by each light receiving portion to obtain a partial image signal, and an image signal representing the radiation image recorded on the stimulable phosphor sheet is obtained by summing the partial image signals obtained by the light receiving portions in each light receiving line arranged in the sub-scanning direction. Each partial image signal is obtained by converting the stimulated light received when the same area on the stimulable phosphor sheet is imaged on the light receiving portions which are arranged in the sub-scanning direction at different timings.

### BACKGROUND OF THE INVENTION

1. Field of the Invention

This invention relates to a method of and a system for obtaining a radiation image signal, and more particularly to a method of and a system for obtaining a radiation image signal where stimulated light generated from a stimulable phosphor sheet on which a radiation image has been recorded is photoelectrically converted to a radiation image signal representing the radiation image.

2. Description of the Related Art

There has been known a radiation image read-out system by the use of a stimulable phosphor sheet. When certain kinds of phosphors are exposed to radiation such as X-rays, they store a part of energy of the radiation. Then when the phosphors which have been exposed to the radiation are exposed to stimulating light such as visible light, light is emitted from the phosphors in proportion to the stored energy of the radiation. Phosphors exhibiting such properties are generally referred to as “stimulable phosphors”. In this specification, the light emitted from the stimulable phosphors upon stimulation thereof will be referred to as “stimulated light”. The stimulable phosphor sheet is a sheet having a layer of stimulable phosphors. In the radiation image read-out system by the use of the stimulable phosphor sheet, a radiation image of an object such as a human body is once recorded on the stimulable phosphor sheet, a stimulating light beam such as a laser beam is subsequently caused to scan the stimulable phosphor sheet to emit the stimulated light therefrom and the stimulated light is photoelectrically read out to obtain an image signal representing the radiation image.

There has been known, as radiation image signal obtaining systems, those comprising a linear light source which projects a line-like stimulating light beam onto the stimulable phosphor sheet as the stimulating light source, a line sensor having a plurality of photoelectric converter elements arranged in a main scanning direction which is the longitudinal direction of the area on the stimulable phosphor sheet exposed to the stimulating light beam by the linear light source as the stimulating light detecting means, and a conveyor means which moves the stimulable phosphor sheet in a sub-scanning direction perpendicular to the main scanning direction relatively to the linear light source and the line sensor in order to shorten the stimulated light reading time and reduce the size and the cost of the system.

Further, as a radiation image signal obtaining system employing a line sensor, there has been known those employing a system where the erected life-size image of the linear area on the stimulable phosphor sheet exposed to the stimulating light beam is imaged on the light receiving face of the line sensor by the use of an imaging optical system comprising, for instance, a refractive index profile type lens and an image signal representing the radiation image is obtained by causing the stimulated light emitted from the linear area to impinge upon the imaging optical system to impinge upon the light receiving face of the line sensor. See, U.S. Patent Application Publication No. 20020028011.

The stimulated light emitted from the stimulable phosphor sheet upon stimulation by the stimulating light is very weak and when the amount of light received by the line sensor is small, the ratio of the noise component in the image signal obtained by the line sensor becomes high. When the ratio of the noise component in the image signal obtained by the line sensor becomes high, the quality of the image representing the radiation image formed on the basis of the image signal deteriorates and accordingly, a system for increasing the amount of the stimulated light received by the line sensor has been investigated.

On the other hand, the stimulating light entering a stimulable phosphor sheet diffuses in the stimulable phosphor sheet to stimulate the stimulable phosphors in the area wider than the stimulating light impinging area on the stimulable phosphor sheet in the sub-scanning direction and stimulated light is emitted from the area of the stimulable phosphor sheet wider than the stimulating light impinging area in the sub-scanning direction. Accordingly, a system where, for instance, stimulated light emitted from the edge of the area wider in the sub-scanning direction can also be received by broadening the light receiving face of the line sensor in the sub-scanning direction and/or by arranging the line sensor in the sub-scanning direction has been investigated.

However, the system where the light receiving face of the line sensor is broadened in the sub-scanning direction is disadvantageous in that the image signal obtained by the line sensor is an image signal which is obtained by photoelectrically converting the stimulated light emitted from the stimulable phosphors in the area wider in the sub-scanning direction though excellent in increasing the amount of the stimulated light received by the line sensor. Accordingly, there has been a problem that the image representing the radiation image obtained on the basis of the image signal thus obtained is low in the resolution in the sub-scanning direction. Thus, there has been a demand to improve the positional resolution in the sub-scanning direction without reducing the amount of the stimulated light received by the line sensor.

### SUMMARY OF THE INVENTION

In view of the foregoing observations and description, the primary object of the present invention is to provide a method of and a system for obtaining a radiation image signal which can improve the quality of the image signal representing the radiation image recorded on a stimulable phosphor sheet.

In accordance with the present invention, there is provided a method of obtaining a radiation image signal wherein

a stimulable phosphor sheet on which a radiation image has been recorded is conveyed in a sub-scanning direction intersecting a main scanning direction relatively to a simulating light beam while projecting the stimulating light beam thereonto in the main scanning direction,

an exposed area on the stimulable phosphor sheet exposed to the stimulating light beam is imaged on each light receiving portion of a line sensor which is formed by causing a light receiving line to correspond to a sub-scanning corresponding direction which corresponds to the sub-scanning direction, a plurality of light receiving portions each receiving and photoelectrically converting stimulated light emitted from the stimulable phosphor sheet exposed to the stimulating light being arranged in a main scanning corresponding direction which corresponds to the main scanning direction to form the light receiving line,

the stimulated light emitted from the exposed area on the stimulable phosphor sheet is received and photoelectrically converted by each of the light receiving portions thereby obtaining a partial image signal by the light receiving portions which represents the amount of the stimulated light received by the light receiving portion, and

an image signal representing the radiation image recorded on the stimulable phosphor sheet is obtained by summing the partial image signals obtained by the light receiving portions in each light receiving line arranged in the sub-scanning corresponding direction,

characterized in that each of the partial image signals to be summed to obtain the image signal is obtained by photoelectrically converting the stimulated light received by each light receiving portion when the same area on the stimulable phosphor sheet is imaged on the light receiving portions which are arranged in the sub-scanning corresponding direction at different timings due to the relative conveyance of the stimulable phosphor sheet.

In accordance with the present invention, there is further provided a system for obtaining a radiation image signal comprising

a stimulating light projecting means which projects a stimulating light beam in a main scanning direction onto a stimulable phosphor sheet on which a radiation image has been recorded,

a stimulable phosphor sheet conveyor means which conveys the stimulable phosphor sheet relatively to a simulating light beam in a sub-scanning direction intersecting the main scanning direction,

a line sensor means which is formed by causing a light receiving line to correspond to a sub-scanning corresponding direction which corresponds to the sub-scanning direction, a plurality of light receiving portions each receiving and photoelectrically converting stimulated light emitted from the stimulable phosphor sheet exposed to the stimulating light being arranged in a main scanning corresponding direction which corresponds to the main scanning direction to form the light receiving line,

an imaging means which images an exposed area on the stimulable phosphor sheet exposed to the stimulating light beam on each light receiving portion of the line sensor,

a summing means which sums up partial image signals obtained by the light receiving portions in each light receiving line arranged in the sub-scanning corresponding direction, thereby obtaining an image signal representing the radiation image recorded on the stimulable phosphor sheet, and

a control means which causes the summing means to sum up the partial image signals by the use of the partial image signals each of which is obtained by the line sensor and represents the amount of stimulated light which has been emitted from the corresponding exposed area to be received by each light receiving portion through the imaging means and thereby photoelectrically converted while conveying the stimulable phosphor sheet by the stimulable phosphor sheet conveyor means while projecting the stimulating light beam thereonto by the stimulating light projecting means,

characterized in that the control means controls the summing means to sum the partial image signals which are obtained by photoelectrically converting the stimulated light received by each light receiving portion when the same area on the stimulable phosphor sheet is imaged on the light receiving portions which are arranged in the sub-scanning corresponding direction at different timings due to the relative conveyance of the stimulable phosphor sheet.

The “exposed area” means an area of the stimulable phosphor sheet including where the stimulating light directly impinges upon and where the stimulable phosphor sheet is exposed to the stimulating light scattered after it directly impinges upon the stimulable phosphor sheet.

The “main scanning corresponding direction” is a direction determined to correspond to the main scanning direction on the image when the area on the stimulable phosphor sheet is imaged on the light receiving portion through the imaging optical system. That is, an area on the stimulable phosphor sheet extending in the main scanning direction is imaged on the light receiving portion as an area extending in the main scanning corresponding direction.

Similarly, the “sub-scanning corresponding direction” is a direction determined to correspond to the sub-scanning direction on the image when the area on the stimulable phosphor sheet is imaged on the light receiving portion through the imaging optical system. That is, an area on the stimulable phosphor sheet extending in the sub-scanning direction is imaged on the light receiving portion as an area extending in the sub-scanning corresponding direction.

“Projecting a stimulating light beam in a main scanning direction” includes “projecting a linear stimulating light beam extending in a main scanning direction” and “scanning a bundle of stimulating light in a main scanning direction”.

The “same area on the stimulable phosphor sheet” may be either a part or the whole of areas on the stimulable phosphor sheet to be imaged on the light receiving portion.

The “control means” may be changed with the timing, at which it photoelectrically converts the stimulated light received by each of the light receiving portions to a partial image signal, according to the kind of the stimulable phosphor sheet used and/or the mode in which the image signal is read out from the stimulable phosphor sheet.

The “control means” may be changed with the timing, at which it photoelectrically converts the stimulated light received by each of the light receiving portions to a partial image signal, on the basis of the partial image signal obtained by the use of a test sample.

In accordance with the method of and the system for obtaining a radiation image signal, since each of the partial image signals to be summed to obtain the image signal representing the radiation image recorded on the stimulable phosphor sheet is obtained by photoelectrically converting the stimulated light received by each light receiving portion when the same area on the stimulable phosphor sheet is imaged on the light receiving portions which are arranged in the sub-scanning corresponding direction at different timings due to the relative conveyance of the stimulable phosphor sheet, the positional resolution in the sub-scanning direction can be improved without reducing the amount of the stimulated light received by each of the light receiving portions.

That is, though areas on the stimulable phosphor sheet different from each other are imaged on the light receiving portions at the same timing, the partial image signals obtained by detection of the stimulated light by each light receiving portion when the same area on the stimulable phosphor sheet which is relatively conveyed in the sub-scanning direction is imaged on each light receiving portion at different timings are summed to obtain the image signal in accordance with the present invention. Accordingly, the image signal obtained by the summation can be an image signal which is obtained by detection of the stimulated light emitted from a narrower area on the stimulable phosphor sheet as compared with the conventional, and at the same time, the amount of stimulated light received by each of the light receiving portions is not reduced to obtain the image signal. With this arrangement, the positional resolution in the sub-scanning direction and the quality of the image signal representing the radiation image can be improved without reducing the amount of the stimulated light received by each of the light receiving portions.

### BRIEF DESCRIPTION OF THE DRAWINGS

FIG. 1 is a perspective view showing in brief a radiation image signal obtaining system in accordance with an embodiment of the present invention,

FIGS. 2A and 2B are partly enlarged views showing reception by each light receiving portion of stimulated light emitted from the stimulable phosphor sheet,

FIG. 3 is a partly enlarged view showing a part of the step of summing up the partial image signals obtained by each light receiving portion to obtain the image signal,

FIG. 4 is a partly enlarged view showing another part of the step of summing up the partial image signals obtained by each light receiving portion to obtain the image signal,

FIG. 5 is a partly enlarged view showing the other part of the step of summing up the partial image signals obtained by each light receiving portion to obtain the image signal,

FIG. 6 is a view showing read-out by each light receiving portion of a stimulable phosphor sheet having an area where the amount of the stored energy of radiation is sharply changed, and

FIG. 7 is a view showing the waveform of the partial image signal output through each light receiving portion.

### DESCRIPTION OF THE PREFERRED EMBODIMENT

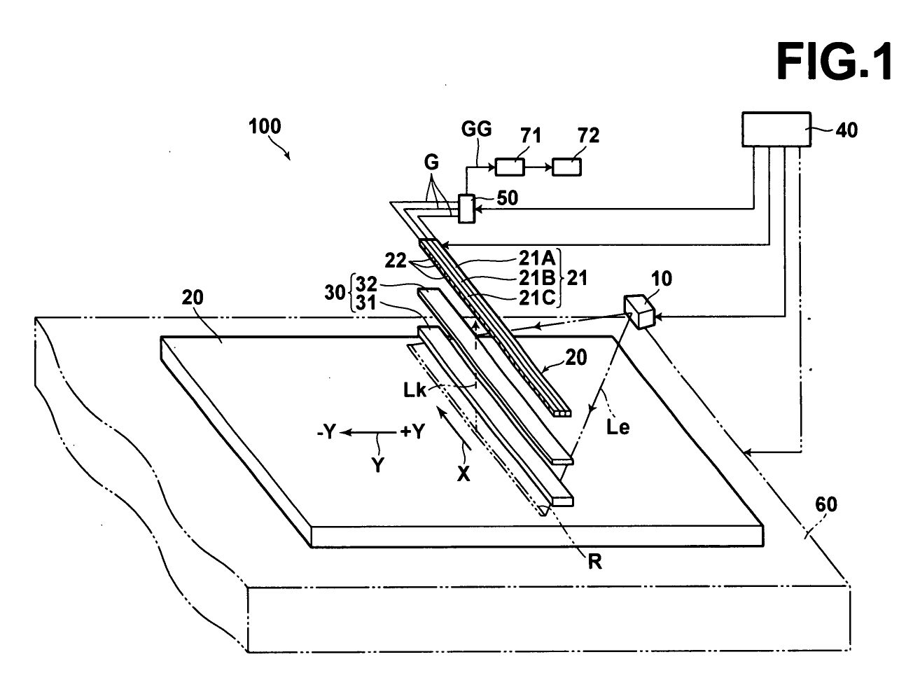

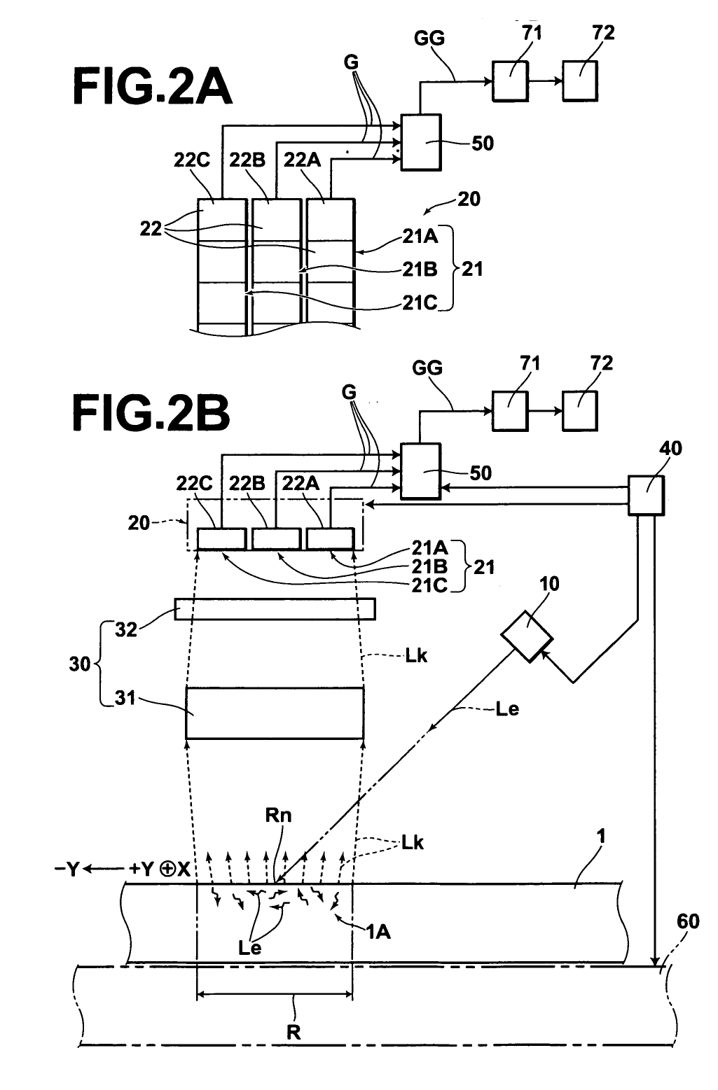

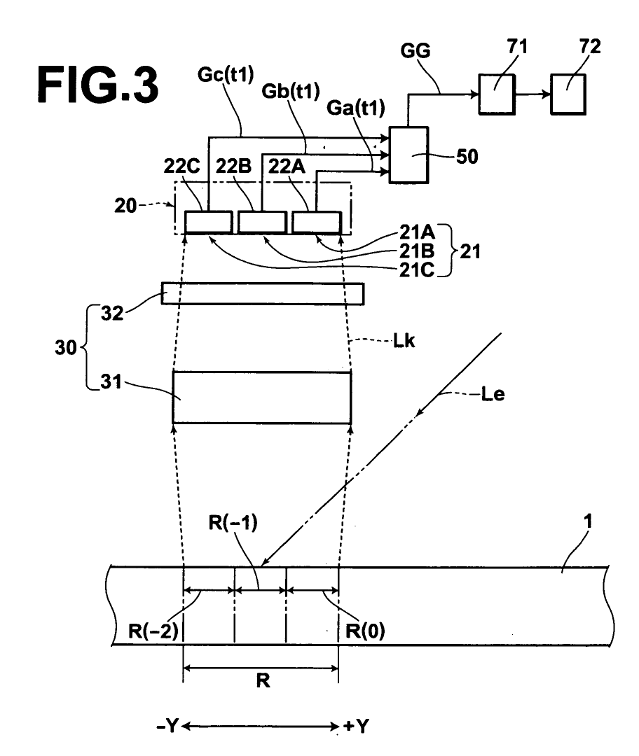

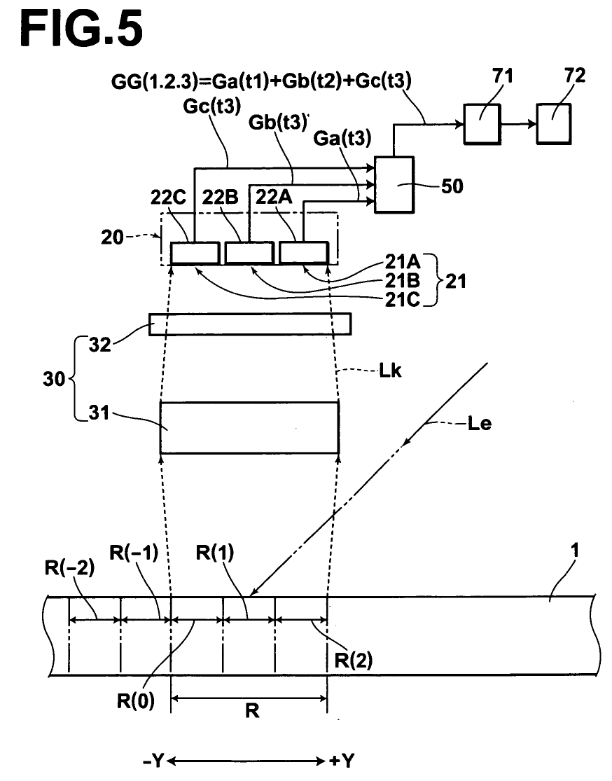

An embodiment of the present invention will be described with reference to the drawings, hereinbelow. FIG. 1 is a perspective view showing in brief a radiation image signal obtaining system for carrying out a method in accordance with an embodiment of the present invention, FIGS. 2 (2A and 2B) are partly enlarged views showing reception of stimulated light emitted from the stimulable phosphor sheet by each light receiving portion of the radiation image signal obtaining system, and FIGS. 3 to 5 are partly enlarged views showing in the same way as in FIG. 2 a part of the step of summing up the partial image signals obtained by each light receiving portion to obtain the image signal. FIGS. 2B and 3 to 5 are views seen in the direction of arrow X in FIG. 1, and FIG. 2A is a view seen from above the light receiving portion shown in FIG. 2B.

The radiation image signal obtaining system 100 in accordance with the embodiment of the present invention shown in FIG. 1 comprises a stimulating light projecting portion 10 which projects a stimulating light Le which is, for instance, of a laser beam and linearly extends in a main scanning direction (indicated at X in FIG. 1) onto a stimulable phosphor sheet 1 on which a radiation image has been recorded, a stimulable phosphor sheet conveyor portion 60 which conveys the stimulable phosphor sheet 1 in a sub-scanning direction (indicated at Y in FIG. 1) intersecting the main scanning direction, a line sensor 20 which is formed of a plurality of light receiving lines 21 arranged in a sub-scanning corresponding direction corresponding to the sub-scanning direction, each of the light receiving lines 21 being formed of a number of light receiving portions 22 which are arranged in a main scanning corresponding direction corresponding to the main scanning direction and each of which receives and photoelectrically converts stimulated light Lk emitted from the stimulable phosphor sheet 1 exposed to the stimulating light Le, thereby obtaining a partial image signal G representing the amount of the stimulated light Lk received by the light receiving portion 22, an imaging portion 30 including a refractive index profile lens array 31 which images an exposed area R on the stimulable phosphor sheet 1 extending in the main scanning direction on each light receiving portion 22 so that the main scanning direction corresponds to the main scanning corresponding direction, and a stimulating light cut filter 32 which cuts the stimulating light Le and transmits the stimulated light Lk, a summing portion 50 which sums the partial image signals G obtained by the light receiving portions 22 in each light receiving line 21 arranged in the sub-scanning corresponding direction and obtains an image signal GG representing the radiation image recorded on the stimulable phosphor sheet 1, and a control portion 40 which causes the summing portion 50 to sum up the partial image signals G by the use of the partial image signals G each of which is obtained by the line sensor 20 and represents the amount of stimulated light Lk which has been emitted from the corresponding exposed area R to be received by each light receiving portion 22 through the imaging portion 30 and thereby photoelectrically converted while conveying the stimulable phosphor sheet 1 by the stimulable phosphor sheet conveyor portion 60 while projecting the stimulating light beam Le thereonto by the stimulating light projecting portion 10.

The control portion 40 controls the summing portion 50 to sum the partial image signals which are obtained by photoelectrically converting the stimulated light received by each light receiving portion when the same area on the stimulable phosphor sheet 1 is imaged on the light receiving portions which are arranged in the sub-scanning corresponding direction at different timings due to the relative conveyance of the stimulable phosphor sheet 1.

The light receiving portion 22 may comprise a photoelectric converter element where the CCD system or the CMOS system is employed. The stimulable phosphor sheet conveyor portion 60 may comprise a known mechanical element. More specifically, the moving mechanism may comprise for instance, a ball and rail system where a movable table for placing the stimulable phosphor sheet is moved along a rail or an air slide system and the driving force transmitting mechanism may comprise, for instance, a rack-and-pinion mechanism, a ball screw and ball bushing mechanism and a piston/cylinder mechanism. As the driving force source, an electric motor, a hydraulic actuator, an air cylinder or the like may be employed.

Operation of the radiation image signal obtaining system 100 will be described, hereinbelow.

While a linear stimulating light beam Le extending in the main scanning direction is projected by the stimulating light projecting portion 10 onto a stimulable phosphor sheet 1 on which a radiation image has been recorded and the stimulable phosphor sheet 1 is conveyed by the stimulable phosphor sheet conveyor portion 60, the stimulated light Lk emitted from each of the exposed areas R on the stimulable phosphor sheet 1 exposed to the stimulating light Le is caused to be received by the corresponding light receiving portion 22 through the imaging portion 30. The stimulating light Le reflected by the stimulable phosphor sheet 1 is cut by the stimulating light cut filter 32 not to be received by the light receiving portion 22.

Each light receiving portion 22 receives and photoelectrically converts stimulated light Lk emitted from the corresponding exposed area R to obtain a partial image signal G representing the amount of the stimulated light Lk which the light receiving portion 22 receives.

Further, the summing portion 50 sums up the partial image signals obtained by the light receiving portions 22 in each of the light receiving line 21 arranged in the sub-scanning corresponding direction and obtains an image signal GG representing the radiation image recorded on the stimulable phosphor sheet 1.

Action of the stimulating light projecting portion 10 and/or the stimulable phosphor sheet conveyor portion 60, the timing at which the light receiving portions 22 in each of the light receiving line 21 arranged in the sub-scanning corresponding direction obtain the partial image signal, summation of the partial image signals and the like are controlled by the control means 40.

Each of the partial image signals G to be summed to obtain the image signal GG will be described in detail here.

As shown in FIG. 2, the stimulating light Le impinging upon a stimulable phosphor sheet 1 is scattered in the stimulable phosphor sheet 1 to expose an exposed area R wider than an entering area Rn over which the stimulating light Le impinges upon a stimulable phosphor sheet 1 and stimulates the stimulable phosphors 1A in the exposed area R. Whereas, an erected life-size image of the exposed area R on the stimulable phosphor sheet 1 is imaged on the light receiving portions 22 by the refractive index profile lens array 31 forming the imaging portion 30.

Accordingly, as shown in FIG. 3, an area R(0) on the stimulable phosphor sheet 1 in the exposed areas R which is positioned on the upstream side in the sub-scanning direction (toward the side indicated at +Y in FIG. 3) in which the stimulable phosphor sheet 1 is conveyed is imaged on a light receiving portion 22A of a light receiving line 21A which is positioned in the light receiving lines 21 on the upstream side in the sub-scanning corresponding direction (toward the side indicated at +Y in FIG. 3). That is, areas R(0), R(−1), R(−2) which are arranged in this order from the upstream side to the downstream side of the sub-scanning direction are respectively imaged on light receiving portions 22A, 22B and 22C arranged in this order from the upstream side in the sub-scanning corresponding direction in light receiving lines 21A, 21B and 21C.

It is assumed that the time at which the state described above is established is t1, and.

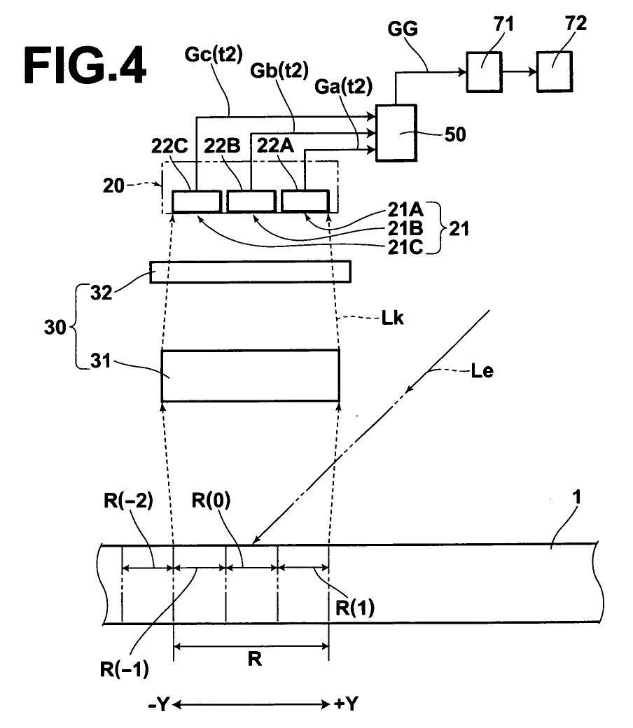

Then, it is assumed that the time when the area R(0) is imaged on the light receiving portion 22B, the area R(−1) is imaged on the light receiving portion 22C and a new area R(1) is imaged on the light receiving portion 22A as the stimulable phosphor sheet 1 is conveyed from the upstream side to the downstream side is t2 and the partial image signals representing the stimulated light Lk respectively received and photoelectrically converted by the light receiving portions 22A, 22B and 22C at time t2 are Ga(t2), Gb(t2) and Gc(t2) as shown in FIG. 4.

Since being deviated from the exposed area R described above at this time, the area R(−2) is not imaged on any of the light receiving portions 22A, 22B and 22C.

Further, it is assumed that the time when the area R(1) is imaged on the light receiving portion 22B, the area R(0) is imaged on the light receiving portion 22C and a new area R(2) is imaged on the light receiving portion 22A as the stimulable phosphor sheet 1 is conveyed from the upstream side to the downstream side is t3 and the partial image signals representing the stimulated light Lk respectively received and photoelectrically converted by the light receiving portions 22A, 22B and 22C at time t3 are Ga(t3), Gb(t3) and Gc(t3) as shown in FIG. 4.

Since being deviated from the exposed area R described above at this time, the areas R(−2) and R(−1) are not imaged on any of the light receiving portions 22A, 22B and 22C.

The summing portion 50 sums up the partial image signals Ga(t1), Gb(t2) and Gc(t3) which are obtained by photoelectrically converting the stimulated light received by each light receiving portion 22 when the same area on the stimulable phosphor sheet 1 is imaged on the light receiving portions 22 which are arranged in the sub-scanning corresponding direction at different timings due to the conveyance of the stimulable phosphor sheet 1 and obtains an image signal GG(1.2.3) representing the radiation image recorded on the stimulable phosphor sheet 1.

The values Ga(t1), Gb(t2) and Gc(t3) of the partial image signals Ga(t1), Gb(t2) and Gc(t3) are obtained by photoelectrically converting the stimulated light received by each of the light receiving portions 22A, 22B and 22C when the same area R(0) is imaged on the light receiving portions 22A, 22B and 22C. Accordingly, the image signal GG(1.2.3) obtained by summing up the partial image signals Ga(t1), Gb(t2) and Gc(t3) represents the values corresponding to the energy of radiation stored in the area R(0) on the stimulable phosphor sheet 1, that is, is an image signal representing the radiation image recorded on the stimulable phosphor sheet 1.

An image signal obtained by summing up partial image signals obtained by photoelectrically converting the stimulated light simultaneously received by each of the light receiving portions as in the conventional system, for instance, an image signal GGc(1.1.1) obtained by summing up partial image signals Ga(t1), Gb(t1) and Gc(t1), is an image signal which represents the values corresponding to the energy of radiation stored in the areas R(0), R(−1) and R(−2) on the stimulable phosphor sheet 1, and since the image signal represents the values corresponding to the energy of radiation stored in the wider area (or the exposed area R) on the stimulable phosphor sheet 1, the positional resolution thereof is lower than that obtained in accordance with the present invention.

When an image signal GG is obtained over the entire area of the stimulable phosphor sheet 1 by control by the control portion 40 in the manner described above, and the image signals GG are synthesized by an image signal synthesizing portion 71, an image signal representing the whole radiation image recorded on the stimulable phosphor sheet 1 can be read out. The image signal synthesized by the image signal synthesizing portion 71 is input into a display device 72 and an image representing the radiation image is displayed.

As can be understood from the description above, in accordance with the present invention, the positional resolution in the sub-scanning direction and the quality of the image signal representing the radiation image recorded on a stimulable phosphor sheet can be improved without reducing the amount of the stimulated light received by each of the light receiving portions.

Though the same area employed in the embodiment described above comprises the whole of the area on the stimulable phosphor sheet 1 imaged on the light receiving portion, the same area may be a part of the area on the stimulable phosphor sheet 1 imaged on the light receiving portion to obtain the same result.

The optimal timing of summation of the partial image signals obtained in the light receiving portions in order to obtain the final synthesized data to be synthesized by the image signal synthesizing portion 71 is changed depending on 1. the beam diameter of the stimulating light, 2. spread of the stimulated light in the stimulable phosphor sheet, 3. the conveying speed of the stimulable phosphor sheet, or 4. the sampling time for photoelectrically converting the stimulated light received by each light receiving portion to obtain the partial image signal. Accordingly, it is preferred to optimally change the timing of summation according to the kind of the stimulable phosphor sheet or the read-out mode in which the stimulable phosphor sheet is read out (e.g., a normal reading or a high speed reading).

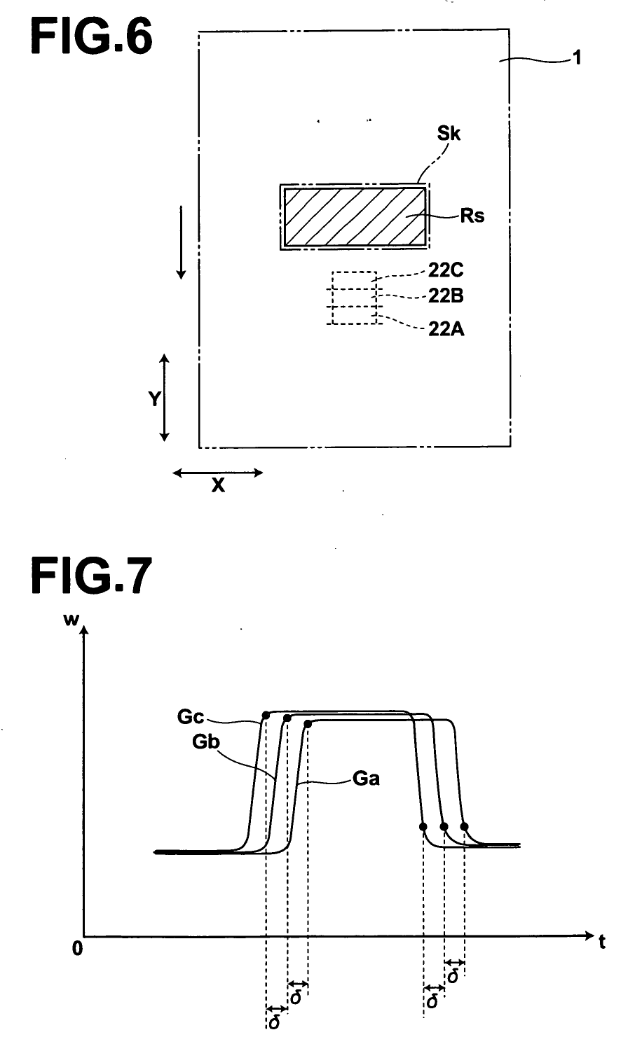

The optimal timing of summation can be determined on the basis of shift of the waveform of the partial image signals output by way of the light receiving portions when an edge of the test sample is read with the light receiving portions. Determination of the timing of summation will be described with reference to FIGS. 6 and 7, hereinbelow.

FIG. 6 is a view showing read-out by each light receiving portion of a stimulable phosphor sheet having an area where the amount of the stored energy of radiation is sharply changed, and FIG. 7 is a view showing the waveform of the partial image signal output to a coordinate system, where the abscissa represents the time t and the ordinate represents the output value W, through each light receiving portion.

A test sample Sk of material which absorbs radiation, for instance, an aluminum block is placed on a stimulable phosphor sheet 1 and a stimulable phosphor sheet having an area Rs where the amount of the stored energy of radiation is sharply changed is obtained by exposing the stimulable phosphor sheet 1 to the radiation through the test sample Sk. The timing of summation is determined on the basis of the waveforms of the partial image signals Gc, Gb and Ga representing the sharp change in the amount of stored radiation energy output from the light receiving portions 22C, 22B and 22A when this stimulable phosphor sheet 1 is read with the radiation image signal read-out system while conveying the stimulable phosphor sheet 1 in the direction of arrow in FIG. 6. That is, it will be apparent that, since the partial image signals Gc, Gb and Ga are shifted by time 6 from each other in phase of the waveform as can be understood from FIG. 7, it is preferred the summation be carried out according to the following formula.

image signal GG=partial image signal Ga(t)+partial image signal Gb(t+δ)+partial image signal Gc(t+2δ)

Though the light receiving lines are 3 in number in the embodiment described above, they may be 2 or more than 4 to obtain the same result.

The summation described above may be a cumulative addition carried out after pretreatment of the partial image signals or before post-treatment of the partial image signals. For example, the summation described above may be weighted additions of a plurality of the partial image signals.

Though, in the embodiment described above, the stimulable phosphor sheet conveyor means conveys the stimulable phosphor sheet in the sub-scanning direction relatively to the stimulating light, the stimulable phosphor sheet conveyor means may convey the stimulating light projecting portion, the imaging portion and the line sensor relatively to the stimulable phosphor sheet or may convey both the stimulating light projecting portion, the imaging portion and the line sensor and the stimulable phosphor sheet relatively to each other.

Though, in the embodiment described above, a linear stimulating light extending in the main scanning direction is projected to obtain stimulated light emitted therefrom, a bundle of the stimulating light may be caused to scan the stimulable phosphor sheet in the main scanning direction to cause the stimulable phosphor sheet to emit stimulated light.

Further, though, in the embodiment described above, an erected, life-size image of the exposed area on the stimulable phosphor sheet is imaged on the light receiving portions, the image imaged on the light receiving portions need not be an erected, life-size image. That is, the image imaged on the light receiving portions may be an erected, non-life-size image or an inverted image.

What is claimed is:

1. A method of obtaining a radiation image signal wherein
a stimulable phosphor sheet on which a radiation image has been recorded is conveyed in a sub-scanning direction intersecting a main scanning direction relatively to a simulating light beam while projecting the stimulating light beam thereonto in the main scanning direction,
an exposed area on the stimulable phosphor sheet exposed to the stimulating light beam is imaged on each light receiving portion of a line sensor which is formed by causing a light receiving line to correspond to a sub-scanning corresponding direction which corresponds to the sub-scanning direction, a plurality of light receiving portions each receiving and photoelectrically converting stimulated light emitted from the stimulable phosphor sheet exposed to the stimulating light being arranged in a main scanning corresponding direction which corresponds to the main scanning direction to form the light receiving line,
the stimulated light emitted from the exposed area on the stimulable phosphor sheet is received and photoelectrically converted by each of the light receiving portions thereby obtaining a partial image signal by the light receiving portions which represents the amount of the stimulated light received by the light receiving portion, and
an image signal representing the radiation image recorded on the stimulable phosphor sheet is obtained by summing the partial image signals obtained by the light receiving portions in each light receiving line arranged in the sub-scanning corresponding direction,
characterized in that each of the partial image signals to be summed to obtain the image signal is obtained by photoelectrically converting the stimulated light received by each light receiving portion when the same area on the stimulable phosphor sheet is imaged on the light receiving portions which are arranged in the sub-scanning corresponding direction at different timings due to the relative conveyance of the stimulable phosphor sheet.

2. A system for obtaining a radiation image signal comprising
a stimulating light projecting means which projects a stimulating light beam in a main scanning direction onto a stimulable phosphor sheet on which a radiation image has been recorded,
a stimulable phosphor sheet conveyor means which conveys the stimulable phosphor sheet relatively to a simulating light beam in a sub-scanning direction intersecting the main scanning direction,
a line sensor means which is formed by causing a light receiving line to correspond to a sub-scanning corresponding direction which corresponds to the sub-scanning direction, a plurality of light receiving portions each receiving and photoelectrically converting stimulated light emitted from the stimulable phosphor sheet exposed to the stimulating light being arranged in a main scanning corresponding direction which corresponds to the main scanning direction to form the light receiving line,
an imaging means which images an exposed area on the stimulable phosphor sheet exposed to the stimulating light beam on each light receiving portion of the line sensor,
a summing means which sums up partial image signals obtained by the light receiving portions in each light receiving line arranged in the sub-scanning corresponding direction, thereby obtaining an image signal representing the radiation image recorded on the stimulable phosphor sheet, and
a control means which causes the summing means to sum up the partial image signals by the use of the partial image signals each of which is obtained by the line sensor and represents the amount of stimulated light which has been emitted from the corresponding exposed area to be received by each light receiving portion through the imaging means and thereby photoelectrically converted while conveying the stimulable phosphor sheet by the stimulable phosphor sheet conveyor means while projecting the stimulating light beam thereonto by the stimulating light projecting means,
characterized in that the control means controls the summing means to sum the partial image signals which are obtained by photoelectrically converting the stimulated light received by each light receiving portion when the same area on the stimulable phosphor sheet is imaged on the light receiving portions which are arranged in the sub-scanning corresponding direction at different timings due to the relative conveyance of the stimulable phosphor sheet.

3. A system for obtaining a radiation image signal as defined in claim 2 in which the control means is changed with the timing, at which it photoelectrically converts the stimulated light received by each of the light receiving portions to a partial image signal, according to the kind of the stimulable phosphor sheet used and/or the mode in which the image signal is read out from the stimulable phosphor sheet.

4. A system for obtaining a radiation image signal as defined in claim 2 in which the control means is changed with the timing, at which it photoelectrically converts the stimulated light received by each of the light receiving portions to a partial image signal, on the basis of the partial image signal obtained by the use of a test sample.

5. A system for obtaining a radiation image signal as defined in claim 2 in which the imaging means images an erected life-size image of the exposed area on the stimulable phosphor sheet on the light receiving portions.

6. A system for obtaining a radiation image signal as defined in claim 3 in which the imaging means images an erected life-size image of the exposed area on the stimulable phosphor sheet on the light receiving portions.

7. A system for obtaining a radiation image signal as defined in claim 4 in which the imaging means images an erected life-size image of the exposed area on the stimulable phosphor sheet on the light receiving portions.
